(19) United States
(12) Patent Application Publication
(10) Pub. No.: US 2019/0284363 A1
(43) Pub. Date: Sep. 19, 2019

(54) POLYURETHANE RIGID FOAM, METHOD FOR PRODUCING SAME, AND USE THEREOF

(71) Applicant: Covestro Deutschland AG, Leverkusen (DE)

(72) Inventors: Reinhard Albers, Leverkusen (DE); Martin Marazita, Langenfeld (DE); Frank Otto, Hilden (DE)

(21) Appl. No.: 16/463,607

(22) PCT Filed: Nov. 24, 2017
(86) PCT No.: PCT/EP2017/080382

§ 371 Date: May 23, 2019

(30) Foreign Application Priority Data
Nov. 29, 2016 (EP) 16201120.9
Dec. 12, 2016 (EP) 16203396.3

(51) Int. Cl. C08J 9/14; C08G 18/76; C08G 18/10; C08G 18/61; C08G 18/50; C08J 9/228; C08G 18/48; B29C 45/00; B29C 44/34; B29C 67/24

(52) U.S. Cl. CPC C08J 9/141; C08G 2101/0025; C08G 18/10; C08G 18/61; C08G 18/5096; C08J 9/228; C08G 18/482; C08G 18/4825; C08G 18/4883; C08G 18/5027; C08G 18/4854; B29C 45/0001; B29C 44/3403; B29C 67/246; C08J 2205/10; C08G 18/7671

(57) ABSTRACT

The invention relates to PUR rigid foams which can be obtained by reacting an organic polyisocyanate component B) in a specified viscosity range with a hydrogen-containing component A) which is reactive to isocyanate groups, at least containing a polyol component, water, and optionally stabilizers, catalysts, and other auxiliary agents and additives, in the presence of suitable propellants and to a method for producing same, having the steps of a) providing a mold, b) introducing the foam-forming reaction mixture of component A), the polyisocyanate component B), and propellants T) into the mold, and c) foaming the reaction mixture.

The present invention relates to rigid polyurethane (PUR) foams, a process for producing these rigid foams by casting and the use thereof.

The term rigid PUR foams or PUR foams will in the following encompass polyurethane foams which partially have polyisocyanurate groups.

Rigid PUR foams have excellent thermal and mechanical properties. Owing to this property, PUR/PIR foams are used in the production of components which insulate against heat and cold, e.g. in refrigeration appliances or in district heating pipes.

The rigid PUR foams can be produced either by continuous processes, as is the case for metal panels or insulation plates, or discontinuous processes, for example in the case of refrigeration appliances, pipes or discontinuous panels.

Rigid PUR foams are usually produced by reacting polyisocyanates with compounds having at least two hydrogen atoms which are reactive toward isocyanate groups, usually a polyol component, in the presence of catalysts, blowing agents and also auxiliaries and/or additives.

In the discontinuous process, an important requirement facing the producing industry is shortening of the demolding time in the production of the components. The different properties of the rigid PUR foams are usually set by modification of the polyol component, including the demolding properties. It is known that high hydroxyl numbers and functionalities of the polyol component have a positive influence on the demolding properties, but such components have high viscosities, so that they can be used in formulations to only a limited extent.

WO 2006/037540 A discloses, for example, a process for producing rigid polyurethane foams by reacting a) polyisocyanates with a polyol component which are produced from a mixture of b1) a polyether polyol having a hydroxyl number of from 360 to 450 mg KOH/g and a viscosity at 25° C. of greater than 12 000 mPa·s, which can be prepared by addition of ethylene oxide and/or propylene oxide onto TDA, b2) a polyether polyol having a functionality of from 5 to 7.5 and a hydroxyl number of from 380 to 480 mg KOH/g, which can be prepared by addition of propylene oxide onto sorbitol and/or sucrose, b3) a polyether polyol having a functionality of from 2 to 4 and a hydroxyl number of from 140 to 250 mg KOH/g, which can be prepared by addition of ethylene oxide and propylene oxide onto TDA, amines different from TDA or of propylene oxide onto bifunctional, trifunctional or tetrafunctional alcohols, or castor oil derivatives. It is said that, in a preferred embodiment of the process, the polyisocyanate has a proportion of 2-ring MDI of from 25 to 38% by weight and a viscosity of from 250 to 1000 mPa·s at 25° C. and consists of a mixture of a component a1) having an NCO content of from 30 to 32% by weight and a viscosity of from 2000 to 2200 mPa·s at 25° C. and a component a2) having an NCO content of from 30 to 32% by weight and a viscosity of from 100 to 120 mPa·s at 25° C. However, no improvement in the after-expansion (as measure of the demolding behavior) can be demonstrated for this preferred embodiment; according to the examples, the demolding behavior improves more or less linearly with increasing viscosity of the isocyanate (examples 12-15), with isocyanates having viscosities of 250 mPa·s, 803 mPa·s, 1050 mPa·s and 1602 mPa·s (25° C.) being used in the examples. The high viscosities again restrict the processing properties (in particular the flowability) of the systems.

US 2012/0264842 A discloses the production of foams for composite systems, in which particular polyol formulations are used in combination with Lupranat® M50 from BASF SE. The object of this patent application is to provide foams for the continuous production of shaped bodies which are composed of rigid PUR foams and have good surface properties. Improvement of discontinuous processing is not discussed in this publication.

Proceeding from the prior art, there is therefore still a need to provide a process for the discontinuous production of shaped bodies composed of rigid PUR foams, which process allows shortening of the demolding time of the shaped bodies without there being restrictions in respect of the mechanical properties or processing properties thereof (e.g. the flowability).

It has now surprisingly been found that when using polymeric MDI in a very particular viscosity range in combination with a specific polyol component in the correct mixing ratio, it is possible to obtain rigid PUR foams which have equally good flow properties and mechanical data compared to the systems comprising polymeric MDI having a viscosity of not more than about 200 mPa·s (25° C.) which are customarily used at present or compared to the systems disclosed in the prior art but display improved demoldability in a discontinuous production process.

The invention provides rigid PUR foams obtainable by reaction of an organic polyisocyanate component B) with a component A) which contains hydrogen atoms which are reactive toward isocyanate groups and contains at least a polyol component A1), water A2) and optionally stabilizers A3), catalysts A4) and other auxiliaries and additives A5) in the presence of suitable blowing agents T), wherein
the polyisocyanate component B) comprises at least 85% by weight (based on the total weight of B) of polymeric MDI which has an NCO content of from ≥29.0% by weight to ≤32.0% by weight and a viscosity at 25° C. (EN ISO 3219, October 1994) of from ≥300 mPas to ≤750 mPa·s and comprises from ≥25% by weight to ≤40% by weight (based on the polymeric MDI) of monomeric MDI; and
the polyol component A1) comprises the following components (i)-(iii), based on the total weight of A1:
(i) 60-75% by weight of polyether polyol Ala) having a hydroxyl number of from 300 mg KOH/g to 600 mg KOH/g and a functionality of from 3.0 to 6.0, which is obtainable by addition of an epoxide onto one or more starter compound(s) selected from the group consisting of carbohydrates and bifunctional or higher-functional alcohols;
(ii) 20-35% by weight of polyether polyol Alb) having a hydroxyl number of from 100 mg KOH/g to 550 mg KOH/g and a functionality of from 1.5 to 5.0, which is obtainable by addition of an epoxide or epoxide mixture onto an aromatic amine;
(iii) 3-10% by weight of polyether polyol Alc) having a hydroxyl number of from 15 mg KOH/g to <300 mg KOH/g and a functionality of from 1.5 to 4.0, which is obtainable by addition of an epoxide or epoxide mixture onto one or more starter compound(s) selected from the group consisting of carbohydrates and bifunctional or higher-functional alcohols.

A mixture of polyol component A1) with water A2) and optionally catalysts A4), stabilizers A3) and other auxiliaries and additives A5) will hereinafter be referred to as component A.

The invention further provides a foam-forming reaction system containing the above-described polyisocyanate component B), the component A) and also the blowing agent T) and a process for producing foamed shaped bodies from this reaction system, comprising the steps:
a) provision of a mold and
b) introduction of the foam-forming reaction mixture composed of component A), blowing agent T) and polyisocyanate component B) into the mold.

Polymeric MDI (pMDI) is used as main constituent of the polyisocyanate component B). For the purposes of the present invention, polymeric MDI is generally a mixture of the isomers of diphenylmethane diisocyanate (“monomeric MDI” or “mMDI”) and oligomers thereof, i.e. the homologues and isomers of MDI having more than two rings, which have at least three aromatic rings and a functionality of at least three (“oligomeric MDI”).

The NCO content is from ≥29.0% by weight to ≤32.0% by weight, based on the total weight of the polymeric MDI. The polymeric MDI has a viscosity at 25° C. of from ≥300 mPas to ≤750 mPa·s, preferably 320-650 mPa·s and particularly preferably 350-550 mPa·s (EN ISO 3219, October 1994) and very particularly preferably 350-500 mPa·s (EN ISO 3219, October 1994). The polymeric MDI comprises, based on its total weight, from ≥25% by weight to ≤40% by weight of monomeric MDI.

The polyisocyanate component preferably contains from ≥25% by weight to ≤40% by weight of monomeric MDI and from ≥50% by weight to ≤75% by weight of oligomeric MDI, based on the total weight of the component B, where the sum of the proportions of monomeric and oligomeric MDI is ≤100% by weight based on the total weight of the isocyanate component.

Apart from the polyphenylmethane polyisocyanates, it is possible to use <25% by weight, in other embodiments preferably <15% by weight and particularly preferably <10% by weight, in particular <5% by weight, of further aliphatic, cycloaliphatic and in particular aromatic polyisocyanates known for the production of polyurethanes, particularly preferably tolylene diisocyanate (TDI).

In a preferred embodiment, the polyisocyanate component B) consists, apart from industrially unavoidable traces of impurities, entirely of polymeric MDI.

The foams are preferably produced at an index of from ≥95 to ≤180, preferably from ≥100 to ≤150, more preferably from ≥102 to ≤135 and particularly preferably from ≥105 to ≤125. Here, the “index” is the ratio of NCO (isocyanate) groups [mol] used in the reaction system to the NCO-reactive groups [mol] present in the reaction system, multiplied by 100. Thus:

Index=(mol of NCO groups/mol of NCO-reactive groups)×100

The polyol component A1) contains 60-75% by weight of Ala) (based on the total weight of the component A1), particularly preferably 65-75% by weight of Ala) polyether polyol having a hydroxyl number of from 300 mg KOH/g to 600 mg KOH/g, preferably from 350 mg KOH/g to 550 mg KOH/g, particularly preferably from 400 mg KOH/g to 500 mg KOH/g, and having a functionality of from 3.0 to 6.0, preferably from 3.5 to 5.5, particularly preferably from 4.5 to 5.5, based on the isocyanate-reactive groups. Polyether polyols Ala) are obtained by addition of one or more epoxides, preferably ethylene oxide and/or propylene oxide, onto one or more starter compound(s) selected from the group consisting of carbohydrates and bifunctional or higher-functional alcohols. For the purposes of the present patent application, the term “epoxides” can also refer to mixtures of various epoxide compounds. The epoxides preferably contain >50% by weight of propylene oxide, based on the total weight of the epoxides, in particular >85% by weight of propylene oxide and very particularly preferably >99% by weight of propylene oxide. A high proportion of propylene oxide in the epoxide mixture has a favorable effect on the reactivity of the polyether polyol. As starter components, preference is given to bifunctional or higher-functional alcohols having vicinal hydroxyl groups. Particular preference is given to starter compound(s) selected from the group consisting of mixtures of sucrose and propylene glycol, of sucrose and ethylene glycol, of sucrose, propylene glycol and ethylene glycol, of sucrose and glycerol, of sorbitol and propylene glycol, of sorbitol and ethylene glycol, of sorbitol, propylene glycol and ethylene glycol, of sorbitol and glycerol, and also mixtures of these mixtures. These preferred starter mixtures have a positive effect on the compressive strength and stability of the foams.

The polyol component A1) additionally contains 15-35% by weight of Alb), preferably 15-30% by weight and particularly preferably 18-30% by weight (based on the total weight of the component A1) of polyether polyol having a hydroxyl number of from 100 mg KOH/g to 550 mg KOH/g, preferably from 200 mg KOH/g to 500 mg KOH/g, particularly preferably from 350 mg KOH/g to 470 mg KOH/g, and a functionality of from 1.5 to 5.0, preferably from 2.0 to 4.5, particularly preferably from 2.5 to 4.0. The polyether polyols Alb) are obtainable by addition of epoxides, preferably ethylene oxide and/or propylene oxide, onto an aromatic amine. The epoxides preferably contain >50% by weight of propylene oxide, based on the total weight of the epoxides, in particular >85% by weight of propylene oxide and very particularly preferably >99% by weight of propylene oxide. The polyether polyol Alb) is particularly preferably started on ortho-, meta- and/or para-toluenediamine, in particular on ortho-toluenediamine or on a mixture of the isomeric toluenediamines. The ortho-toluenediamine which is particularly preferably to be used preferably contains from 40 to 50% by weight of 2,3-diaminotoluene and from 50 to 60% by weight of 3,4-diaminotoluene, in each case based on the total mass of the ortho-toluenediamine used.

The polyol component A1) additionally contains 3-10% by weight, preferably 4-9% by weight, particularly preferably 4-7% by weight (based on the total weight of the component A1), of Alc) polyether polyol having a hydroxyl number of from 15 mg KOH/g to <300 mg KOH/g, preferably from 50 mg KOH/g to 250 mg KOH/g, particularly preferably from 75 mg KOH/g to 200 mg KOH/g, and having a functionality of from 1.5 to 4.0, preferably from 2.0 to 3.5, particularly preferably from 2.0 to 3.0. Alc) is obtained by addition of one or more epoxides, preferably ethylene oxide and/or propylene oxide, onto one or more starter compound(s) selected from the group consisting of carbohydrates and bifunctional or higher-functional alcohols. The epoxides preferably contain >50% by weight of propylene oxide, based on the total weight of the epoxides, in particular >85% by weight of propylene oxide and very particularly preferably >99% by weight of propylene oxide. As starter components, preference is given to bifunctional or higher-functional alcohols having vicinal hydroxyl groups. Starter compound(s) are particularly preferably selected from the group consisting of glycerol, mixtures of glycerol and propylene glycol, trimethylolpropane, mixtures of trimethylolpropane and propylene glycol, and propylene glycol and also mixtures of these components.

In particular embodiments, the polyol component A1) can additionally contain <22% by weight, preferably <10% by weight and very particularly preferably ≤5% by weight (based on the total weight of the component A), of (iv) further isocyanate-reactive compounds Ald).

A1d) comprises, inter alia, polyols which are known in principle to those skilled in the art, for example aa) polyester polyols, bb) polyester polyether polyols and cc) polyether polyols which do not come under the definition of A1a), A1b) or A1c). The methods of preparing such polyols have been described many times in the literature. Thus, polyester polyols can be obtained by polycondensation of dicarboxylic acid equivalents and low molecular weight polyols. Polyether polyols are obtained by polyaddition (anionic or cationic) of epoxides onto suitable starter compounds. The addition of epoxides onto polyester polyols or the esterification of dicarboxylic acid equivalents and polyether polyols leads to polyester polyether polyols. If required, the polymerization reactions are carried out in the presence of suitable catalysts which are known to those skilled in the art.

In particular, cc) a short-chain polyether polyol which is started on an aliphatic amine or a polyhydric alcohol and has a hydroxyl number of from 500 mg KOH/g to 1000 mg KOH/g, preferably from 600 mg KOH/g to 950 mg KOH/g, particularly preferably from 700 mg KOH/g to 900 mg KOH/g, and has a functionality of from 1.5 to 5.0, preferably from 2.0 to 4.5, particularly preferably from 2.5 to 4.0, can be present. This polyether polyol is particularly preferably obtained by addition of epoxides onto ethylenediamine or trimethylolpropane. Preferred epoxides are ethylene oxide and propylene oxide, with particular preference being given to propylene oxide.

It can also be advantageous for A1d) also to contain dd) one or more bifunctional to tetrafunctional amine-type and/or alcoholic chain extenders or crosslinkers. These are preferably selected from among glycerol, butanediol, ethylene glycol, diethylene glycol, propylene glycol, ethylenediamine, ethanolamine, triethanolamine, trimethylolpropane and pentaerythritol and are preferably present in amounts of from 0 to 5% by weight, based on the component A1).

In the polyol mixture A1) or in Ald) it is likewise possible to use, in addition, ee) polyether carbonate polyols as are obtainable, for example, by catalytic reaction of epoxides and carbon dioxide in the presence of H-functional starter substances (see, for example, EP 2 046 861 A1). These polyether carbonate polyols generally have a functionality of greater than or equal to 1.0, preferably from 2.0 to 8.0, particularly preferably from 2.0 to 7.0 and very particularly preferably from 2.0 to 6.0. The number average molar mass is preferably from 400 g/mol to 10 000 g/mol and particularly preferably from 500 g/mol to 6000 g/mol.

The number average molar mass Mₐ is, for the purposes of the present invention, determined by gel permeation chromatography in accordance with DIN 55672-1 of August 2007.

The “hydroxyl number” indicates the amount of potassium hydroxide in milligrams which is equivalent to the amount of acetic acid bound by one gram of substance in an acetylation. For the purposes of the present invention, it is determined in accordance with the standard DIN 53240-2 (1998).

“Functionality” refers, for the purposes of the present invention, to the theoretical average functionality calculated from the known starting materials and the ratios thereof (number of functions in the molecule which are reactive toward isocyanates or toward polyols).

For the purposes of the present patent application, the term “polyether polyol” refers to both individual compounds and also mixtures of polyether polyols having the features mentioned in each case.

The isocyanate-reactive component A) contains water A2) which functions as co-blowing agent, preferably in an amount of from ≥1.5% by weight to ≤4.0% by weight, preferably from ≥2.0% by weight to ≤3.0% by weight, particularly preferably from ≥2.2% by weight to ≤2.7% by weight (based on the total weight of the component A).

Possible foam stabilizers A3), which can optionally be added to the component A), are in particular polyether siloxanes. These compounds generally have a structure in which a copolymer of ethylene oxide and propylene oxide is joined to a polydimethylsiloxane radical. These stabilizers are usually employed in amounts of from 0.5% by weight to 5% by weight, preferably from 1.0% by weight to 4% by weight, particularly preferably from 1.5% by weight to 3.0% by weight, based on the component A.

Catalysts A4) customary in polyurethane chemistry are added to the component A). The amine catalysts required for producing a rigid PUR foam are preferably used in amounts of from 0.05 to 4% by weight, based on the component A, and the salts used as trimerization catalysts are usually employed in amounts of from 0.1 to 5% by weight.

As catalysts A4), use is made of, for example:
triethylenediamine, N,N-dimethylcyclohexylamine, dicyclohexylmethylamine, tetramethylenediamine, 1-methyl-4-dimethylaminoethylpiperazine, triethylamine, tributylamine, dimethylbenzylamine, N,N′,N″-tris(dimethylaminopropyl)hexahydrotriazine, tris(dimethylaminopropyl)amine, tris(dimethylaminomethyl)phenol, dimethylaminopropylformamide, N,N,N′,N′-tetramethylethylenediamine, N,N,N′,N′-tetramethylbutanediamine, tetramethylhexanediamine, pentamethyldiethylenetriamine, pentamethyldipropylenetriamine, bis(dimethylaminoethyl) ether, dimethylpiperazine, 1,2-dimethylimidazole, 1-azabicyclo[3.3.0]octane, bis(dimethylaminopropyl)urea, N-methylmorpholine, N-ethylmorpholine, sodium N-[ (2-hydroxy-5-nonylpheny pmethyl]-N-methylaminoacetate, N-cyclohexylmorpholine, 2,3-dimethyl-3,4,5,6-tetrahydropyrimidine, triethanolamine, diethanolamine, triisopropanolamine, N-methyldiethanolamine, N-ethyldiethanolamine, dimethylethanolamine, bis[2-(N,N-dimethylamino)ethyl] ether,
if necessary (if high proportions of polyisocyanurate are wanted) together with at least one catalyst selected from the group consisting of
tin(II) acetate, tin(II) octoate, tin(II) ethylhexanoate, tin(II) laurate, dibutyltin diacetate, dibutyltin dilaurate, dibutyltin maleate, dioctyltin diacetate, tris(N,N-dimethylaminopropyl)-s-hexahydrotriazine, tetramethylammonium hydroxide, sodium acetate, sodium octoate, potassium acetate, potassium octoate, sodium hydroxide.
The catalyst preferably contains one or more catalysts selected from the group consisting of potassium acetate, potassium octoate, pentamethyldiethylenetriamine, N,N′,N″-tris(dimethylaminopropyl)hexahydrotriazine, tris(dimethylaminomethyl)phenol, bis[2-(N,N-dimethylamino)ethyl] ether and N,N-dimethylcyclohexylamine, particularly preferably from the group consisting of pentamethyldiethylenetriamine, N,N′,N″-tris(dimethylaminopropyl)hexahydrotriazine and N,N-dimethylcyclohexylamine.

Flame retardants can be added to the polyol component, particularly preferably in an amount of from 0 to 10% by weight, based on the component A). Such flame retardants are known in principle to a person skilled in the art and are described, for example, in “Kunststoffhandbuch”, volume 7 “Polyurethane”, chapter 6.1. These can be, for example, bromine- and chlorine-containing paraffins or phosphorus compounds, for example the esters of orthophosphoric acid and of metaphosphoric acid, which can likewise contain halogen. Examples are triethyl phosphate, diethyl ethanephosphonate, cresyl diphenyl phosphate, dimethyl propanephosphonate and tris((3-chloroisopropyl)phosphate. Flame retardants which are liquid at room temperature are preferably chosen. In order to achieve particular property profiles (viscosity, brittleness, combustibility, halogen content, etc.), it can be advantageous to combine various flame retardants with one another.

To influence the lambda aging behavior, to improve the burning behavior and further mechanical properties, solid additives such as nanoparticles, lime, minerals, pigments, graphite, can be added to the polyol component. Further examples of solid additives which may optionally be concomitantly used in the polyol formulation of the invention are known from the literature. The amounts are in the range from 0 to 30% by weight, based on component A.

The reaction mixture also contains such an amount of blowing agent T) as is necessary to achieve a dimensionally stable foam matrix and the desired foam density. In general, this is 0.5-20 parts by weight of blowing agent T based on 100 parts by weight of the component A. As blowing agents T, preference is given to using physical blowing agents selected from at least one member of the group consisting of hydrocarbons, halogenated ethers and perfluorinated hydrocarbons having from 1 to 8 carbon atoms. For the purposes of the present invention, “physical blowing agents” are compounds which are readily volatile because of their physical properties and do not react with the isocyanate component. The physical blowing agents to be used according to the invention are preferably selected from among hydrocarbons (e.g. n-pentane, isopentane, cyclopentane, butane, isobutane), ethers (e.g. methylal), halogenated ethers, perfluorinated hydrocarbons having from 1 to 8 carbon atoms (e.g. perfluorohexane) and also mixtures of these with one another. The use of (hydro)fluorinated olefins, e.g. HFO 1233zd(E) (trans-1-chloro-3,3,3-trifluoro-1-propene) or HFO 1336mzz(Z) (cis-1,1,1,4,4,4-hexafluoro-2-butene), or additives such as FA 188 from 3M (1,1,1,2,3,4,5,5,5-nonafluoro-4-(trifluoromethyl)pent-2-ene) is also preferred. In particularly preferred embodiments, a pentane isomer or a mixture of various pentane isomers is used as blowing agent T. Especial preference is given to using cyclopentane as blowing agent T. Further examples of fluorinated hydrocarbons which are preferably used are HFC 245fa (1,1,1,3,3-pentafluoropropane), HFC 365mfc (1,1,1,3,3-pentafluorobutane), HFC 134a or mixtures thereof. It is also possible to combine various classes of blowing agent, e.g. mixtures of hydrocarbons, in particular various pentane isomers, can be combined with fluorinated hydrocarbons. Thus, for example, thermal conductivities, measured at 10° C., of less than 20 mW/mK can be achieved using mixtures of n- or i-pentane with HFC 245fa in a ratio of 75:25 (n-/i-pentane:HFC 245fa). Particular preference is given to using cyclopentane as blowing agent T.

The invention further provides a foam-forming reaction system containing the above-described polyisocyanate component B) and the above-described component A) and also a process for producing foamed shaped bodies composed of rigid PUR foams, comprising the steps:

a) provision of a mold and
b) introduction of the foam-forming reaction mixture composed of component A), polyisocyanate component B) and blowing agent T) into the mold.

Use of the reaction system according to the invention in this process leads, in particular, to good dimensional accuracy (swelling behavior) of the foam during processing combined with overall very good processing properties. The swelling behavior is critical in determining the time after which a shaped body can be removed from the mold (demoldability). The rigid foams of the invention display a good property profile, in particular low thermal conductivity values.

The rigid PUR foams of the invention are produced by reacting the reaction components using methods known to those skilled in the art.

The mold provided in step a) of the process of the invention can be a closed or open mold. Here, “open” means that at least two side walls are present. The foam obtained can be taken from the mold or remain in the mold for its final purpose. A mold by means of which one-piece insulations for refrigeration appliances are produced is particularly suitable according to the invention. The mold is preferably arranged in such a way that the reaction mixture introduced into it can spread over the bottom of the mold.

In step b), the foam-forming reaction mixture can, for example, be produced by means of a conventional high-pressure mixing unit and introduced into the mold by means of a discharge tube. The mixing unit can comprise a mixing chamber into which the individual components of the reaction mixture are fed.

An example of a conventional process for producing insulation for refrigeration appliances is filling of the mold in the tub position, with the appliance lying on the rear wall being filled either from the compressor stage or the top region. Such a process is described, for example, in EP 2 148 156 A. A further example of a further-derived conventional process is the “top flow” process in which the reaction mixture is introduced from the bottom into a mold and can thus spread over the bottom of the mold.

To achieve better distribution, it can be advantageous to introduce the foam-forming reaction mixture into the mold under a variable injection pressure and/or in an amount which changes over time, as is described, for example, in EP 2 844 394 A. It is possible to use either one discharge tube or a plurality of discharge tubes (multipoint injection) per mold.

During or after step b), foam formation c) from the foam-forming reaction mixture takes place.

In order to achieve better distribution of the reaction mixture and/or controlled foam formation, it can be advantageous to carry out the filling process and/or foam formation under reduced pressure. In this vacuum-assisted foaming, the reaction mixture is introduced into a foam mold, with subatmospheric pressure being generated in the foam mold before, during or after introduction of the reaction mixture.

After foam formation is complete, the mixture is cured and removed from the mold.

The process of the invention makes it possible for a processor to produce shaped bodies composed of rigid PUR foams discontinuously with a demolding time for the shaped bodies which is shortened compared to the standard process without their mechanical properties or processing properties (e.g. the flowability) being impaired.

The present invention further provides composite systems containing the shaped bodies composed of the rigid PUR foams of the invention, obtainable by the above-described process of the invention. The composite systems are often bounded by decor layers both on the upper side and on the underside. Possible decor layers are, inter alia, metals, polymers, wood and paper. As fields of use of such discontinuously produced PUR composite systems, particular mention may be made of the industrial insulation of appliances such as refrigerators, refrigeration chests, refrigerator-freezer combinations and boilers, insulated containers and cold boxes and also pipes.

The use of rigid PUR foams in these fields is known in principle to a person skilled in the art and has been described many times. The rigid PUR foams of the invention are extremely well suited for these purposes since they have low thermal conductivity values without processing problems as a result of excessively high viscosities or unfavorable swelling behavior having to be feared in the production of the foams or application thereof to suitable substrates (e.g. housings of refrigeration appliances or pipes).

The invention additionally provides a refrigerator, a freezer or a refrigerator-freezer combination comprising a foamed shaped body which is obtainable according to the invention, with the mold provided being, in particular, a housing part of the refrigerator, of the freezer or of the refrigerator-freezer combination. The invention will be illustrated with the aid of the following examples.

### EXAMPLES

Starting Materials:

Polyol PA: Polyether polyol derived from sucrose, propylene glycol, ethylene glycol and propylene oxide and having a functionality of 4.7 and a hydroxyl number of 450 mg KOH/g.

Polyol PB: Polyether polyol derived from sorbitol, glycerol and propylene oxide and having a functionality of 5.5 and a hydroxyl number of 477 mg KOH/g.

Polyol PC: Polyether polyol derived from TDA and propylene oxide and having a functionality of 4 and a hydroxyl number of 360 mg KOH/g.

Polyol PD: Polyether polyol derived from propylene glycol and propylene oxide and having a functionality of 2 and a hydroxyl number of 112 mg KOH/g.

Stabilizer: Tegostab® B 8522, Evonik Nutrition & Care GmbH

Catalyst KA: Pentamethyldiethylenetriamine Catalyst KB: N,N′,N″-Tris(dimethylaminopropyl)hexahydrotriazine

Catalyst KC: Tris(dimethylaminomethyl)phenol

Catalyst KD: N,N-Dimethylcyclohexylamine

Catalyst KE: Mixture of ethanediol and the salt of N,N,N-methanaminium and pivalic acid (50 parts by weight: 50 parts by weight)

Isocyanate IA: polymeric MDI containing 49.5% by weight of diphenylmethane 4,4′-diisocyanate (mMDI), viscosity from ≥160 mPas to ≤300 mPas at 25° C., NCO content 31.3% by weight, Covestro Deutschland AG

Isocyanate IB: polymeric MDI containing 35.2% by weight of diphenylmethane 4,4′-diisocyanate (mMDI), viscosity from ≥350 mPas to ≤450 mPas at 25° C., NCO content 31.1% by weight, Covestro Deutschland AG

Isocyanate IC: polymeric MDI containing 30.6% by weight of diphenylmethane 4,4′-diisocyanate (mMDI), viscosity from ≥610 mPas to ≤750 mPas at 25° C., NCO content 30.9% by weight, Covestro Deutschland AG

Isocyanate ID: polymeric MDI containing 22.8% by weight of diphenylmethane 4,4′-diisocyanate (mMDI), viscosity from ≥1500 mPas to ≤2500 mPas at 25° C., NCO content 29.0-32.0% by weight, Covestro Deutschland AG

Hydroxyl number (OH number): The determination of the OH number was carried out in accordance with the method of DIN 53240-2 (1998).

Isocyanate content: EN ISO 11909:2007 “Determination of the isocyanate content”

Viscosity: DIN EN ISO 3219:1994 “Plastics—polymers/resins in the liquid state or as emulsions or dispersions”

### Experiments 1-6 (table 1)

On a high-pressure polyurethane metering machine model A40 from Cannon, the polyol formulation composed of the amounts of polyols, water, stabilizer, catalysts indicated in table 1 together with the blowing agent was mixed with the isocyanate in an FPL mixing head (from Cannon) having an outflow tube diameter of 18 mm and discharged. The circulation pressure for the components was regulated to about 150 bar and the container temperatures for the components were regulated to 20° C. The discharge rate of the mixture was set to 350 g/s.

The thermal conductivity was determined in accordance with DIN 52616 (1977). For this purpose, the polyurethane reaction mixture was poured into a 200×20×5 cm mold with an introduced density of 37 kg/m³. After 6 minutes, the test specimen was taken from the mold and two test specimens having dimensions of 20×20×3 cm were promptly cut from the molded body.

The compressive strength was determined in accordance with DIN EN 826 (2013). For this purpose, the polyurethane reaction mixture was poured into a 200×20×5 cm mold with an introduced density of 36 kg/m³. After 5 minutes, the test specimen was removed from the mold and, after storage for 24 hours, 20 test specimens having a size of 5×5×4 cm were cut from various regions of the test specimen and the compressive strength was determined in accordance with the DIN standard indicated.

To determine the swelling behavior, the polyurethane reaction mixture was introduced into a mold which had been preheated to 45° C. and had the dimensions 70×40×9 cm with an apparent density of 36 kg/m³ and removed from the mold after 5 minutes. The test specimen was stored for 24 hours and the thickness of the test specimen was subsequently determined.

The apparent core density was determined in accordance with DIN EN ISO 845:2009 (“Cellular plastics and rubbers—determination of apparent density”).

TABLE 1

| | | | | | |
|---|---|---|---|---|---|
| 1* | 2* | 3* | 4 | 5 | 6 |

Polyol formulation (parts by weight)

| | | | | | | |
|---|---|---|---|---|---|---|
| Polyol PA | 32.5 | | 32.5 | 32.5 | | 32.5 |
| Polyol PB | 32.5 | 65.0 | 32.5 | 32.5 | 65.0 | 32.5 |
| Polyol PC | 30.0 | 30.0 | 30.0 | 30.0 | 30.0 | 30.0 |
| Polyol PD | 5.0 | 5.0 | 5.0 | 5.0 | 5.0 | 5.0 |
| Water | 2.65 | 2.65 | 2.65 | 2.65 | 2.65 | 2.65 |
| Stabilizer | 2.0 | 2.0 | 2.0 | 2.0 | 2.0 | 2.0 |
| Catalyst KA | 0.6 | 0.6 | 0.6 | 0.6 | 0.6 | 0.6 |
| Catalyst KB | 0.5 | 0.5 | | 0.5 | 0.5 | |
| Catalyst KC | 0.4 | 0.4 | | 0.4 | 0.4 | |
| Catalyst KD | 0.85 | 0.85 | 0.85 | 0.85 | 0.85 | 0.85 |
| Catalyst KE | | | 0.8 | | | 0.8 |

Reaction system (parts by weight)

| | | | | | | |
|---|---|---|---|---|---|---|
| Polyol formulation | 100 | 100 | 100 | 100 | 100 | 100 |
| Cyclopentane | 14 | 14 | 14 | 14 | 14 | 14 |
| Isocyanate IA | 149 | 151 | 150 | | | |
| Isocyanate IB | | | | 149 | 151 | 149 |
| Index | 113 | 113 | 113 | 112 | 112 | 112 |

Properties

| | | | | | | |
|---|---|---|---|---|---|---|
| Fiber time [s] | 38 | 39 | 44 | 36 | 42 | 46 |
| Free-foamed density [g/l] | 23.3 | 22.9 | 22.3 | 22.8 | 23.7 | 23.1 |
| Min. fill density [g/l] | 31.8 | 30.9 | 30.9 | 32.0 | 32.2 | 31.8 |
| Compressive strength at 36 kg/m³ | 159 | 170 | 165 | 162 | 163 | 154 |
| [kPa] | | | | | | |
| Apparent core density at 36 kg/m³ | 31.7 | 32.1 | 31.8 | 31.5 | 31.7 | 31.7 |
| Thermal conductivity [mW/mK] | 19.2 | 19.1 | 19.4 | 19.1 | 19.1 | 19.2 |
| 10° C. | | | | | | |
| Swelling behavior after 24 h, 5′ | 91.5 | 91.6 | 91.8 | 90.7 | 90.7 | 91.0 |
| 36 kg/m³ [mm] | | | | | | |

*Comparative examples

### Experiments 7-10 (Table 2)

In a suitable vessel, a total of 100 g of the polyol formulation made up of the amounts of polyols, water, stabilizer, catalysts indicated in table 2 were admixed with cyclopentane and brought to 20° C. At the same time, the isocyanate component was likewise brought to 20° C. in a second suitable vessel. The required amount of the isocyanate component was subsequently added to the mixture of polyol formulation and blowing agent and all the constituents were mixed intensively with one another for 6 seconds. The reaction mixture was then poured into a test package (20×20 cm′) and the reactivity indicators were determined as follows:

The cream time corresponds to the time required by the reaction mixture until it begins to foam. To determine the fiber time, a wooden stick was dipped into the rising foam and pulled out again. The point in time at which the wooden stick draws threads on being pulled out of the foam corresponds to the fiber time of the foam.

To examine the flow properties of the foams, the reaction vessel was, after the stirring operation using an amount of the reaction mixture standardized for this method (265 g), introduced into a heatable rise tube (rigid foam rise tube) having a height of 150 cm and an internal diameter of 9.1 cm. The temperature of the rise tube was 35° C. The rise height and the pressure were detected as a function of time and corrected according to the respective prevailing air pressure to a standard pressure of 1013 mbar. The point in time at which a sudden pressure increase is detected corresponds to the gel point or the gel time of the foam. The following parameters need to be distinguished: tG (gel point, in s) and hG (height at the time of tG, in cm).

To determine the free-foamed density, a foam was produced as described above and this was subsequently stored for 24 hours at room temperature. A 10×10×10 cm³ cube is cut from the center of the test specimen. The mass of the test specimen is determined by weighing and the apparent density is calculated as the ratio of mass to volume and is reported in kg/m³.

To determine the swelling behavior, the polyurethane reaction mixture was poured into a mold having the dimensions 22×22×10 cm³ with overfilling by 25% and was removed from the mold after the indicated mold residence time (MRT). After 30 minutes, the thickness of the molded body was determined.

The compressive strength was determined in accordance with DIN EN 826 (2013). For this purpose, an amount of polyurethane reaction mixture which gave an introduced density of 36 kg/m³ was introduced into a 22×22×10 cm³ mold. This molded body was removed from the mold after the indicated mold residence time (MRT). After 24 hours, 10 test specimens having the dimensions 5×5×5 cm³ were cut and the compressive strength of each of 5 test specimens was determined both in the thickness direction and also perpendicularly thereto.

The thermal conductivity was determined in accordance with DIN 52616 (1977). For this purpose, the polyurethane reaction mixture was poured into a 22×22×6 cm³ mold with overfilling by 10%. This molded body was removed from the mold after 6 minutes. After a few hours, a test specimen having the dimensions 20×20×3 cm³ was cut and the thermal conductivity was determined in accordance with the standard.

The apparent core density was determined in accordance with DIN EN ISO 845:2009 (“Cellular plastics and rubbers—determination of apparent density”).

TABLE 2

| | 1* | 2 | 3 | 4* |
|---|---|---|---|---|
| Polyol PA | 32.50 | 32.50 | 32.50 | 32.50 |
| Polyol PB | 32.50 | 32.50 | 32.50 | 32.50 |
| Polyol PC | 30.00 | 30.00 | 30.00 | 30.00 |
| Polyol PD | 5.00 | 5.00 | 5.00 | 5.00 |
| Water | 2.65 | 2.65 | 2.65 | 2.65 |
| Stabilizer | 2.00 | 2.00 | 2.00 | 2.00 |
| Catalyst KA | 0.60 | 0.60 | 0.60 | 0.60 |
| Catalyst KB | 0.50 | 0.50 | 0.50 | 0.50 |
| Catalyst KC | 0.40 | 0.40 | 0.40 | 0.40 |
| Catalyst KD | 0.85 | 0.80 | 0.85 | 0.74 |
| Polyol formulation | 100 | 100 | 100 | 100 |
| Cyclopentane | 14.5 | 15.0 | 16.0 | 15.0 |
| Isocyanate IA | 149.0 | | | 95.0 |
| Isocyanate IB | | 152.0 | | |
| Isocyanate IC | | | 153.0 | |
| Isocyanate ID | | | | 56.0 |
| Index | 113 | 113 | 113 | 113 |

Processibility

| | | | | |
|---|---|---|---|---|
| Cream time [s] | 9 | 9 | 9 | 9 |
| Fiber time [s] | 61 | 59 | 60 | 58 |
| Gel time tG [s] | 64 | 63 | 65 | 64 |
| Flow height at tG | 118.4 | 118.1 | 118.3 | 117 |
| (1013 hPA) [cm] | | | | |

Foam properties

| | | | | |
|---|---|---|---|---|
| Free-foamed density | 23.3 | 23.3 | 22.4 | 23 |
| [g/l] | | | | |
| Compressive strength | 144 ± 18 | 147 ± 24 | 152 ± 27 | 142 ± 18 |
| at 36 kg/m³ [kPa] | | | | |
| Apparent core density | 32.2 ± 0.3 | 32.6 ± 0.4 | 31.9 ± 0.3 | 32.2 ± 0.3 |
| at 36 kg/m³ | | | | |
| Thermal conductivity | 20.0 | 19.5 | 19.4 | 19.8 |
| [mW/mK] 10° C. | | | | |
| Swelling behavior, | 1.4 | 0.6 | 1.2 | 1.4 |
| MRT 5 min (10 cm) | | | | |
| [mm] | | | | |

*Comparative examples

The experiments show that the inventive combination of polyols and isocyanates makes it possible to obtain rigid PUR/PIR foams which display equally good processibility in a discontinuous process and have a low thermal conductivity and a better swelling behavior than when using polymeric MDI in a different viscosity range. The lower values for the swelling behavior show that the shaped bodies composed of the rigid polyurethane foams according to the invention can be demolded after a shorter time.

### Experiments 11-14 (Table 3)

Further polyurethane foams 11-14 which differ in terms of the composition of the polyol formulation were produced and tested in a manner analogous to experiments 7-10 (see table 3). The foams 11 and 12* were blown using cyclopentane, the foams 13 and 14* were blown using n-pentane.

Comparative experiments 12* and 14* contain a polyol system which in terms of its composition corresponds to systems of the prior art (US2012/0264842).

TABLE 3

| | 11 | 12* | 13 | 14* |
|---|---|---|---|---|
| Polyol formulation | 1 | 2 | 3 | 4 |
| (parts by weight) | | | | |
| Polyol PA | — | — | — | — |
| Polyol PB | 65.00 | 54.80 | 65.00 | 54.80 |
| Polyol PC | 30.00 | 19.40 | 30.00 | 19.40 |
| Polyol PD | 5.00 | 25.80 | 5.00 | 25.80 |
| Water | 2.65 | 2.65 | 2.65 | 2.65 |
| Stabilizer | 2.00 | 2.00 | 2.00 | 2.00 |
| Catalyst KA | 0.60 | 0.60 | 0.60 | 0.60 |
| Catalyst KB | 0.50 | 0.50 | 0.50 | 0.50 |
| Catalyst KC | 0.40 | 0.40 | 0.40 | 0.40 |
| Catalyst KD | 0.85 | 0.85 | 0.85 | 0.85 |
| Reaction system | | | | |
| (parts by weight) | | | | |
| Polyol formulation | 100.0 | 100.0 | 100.0 | 100.0 |
| Cyclopentane | 14.5 | 14.5 | | |
| n-Pentane | | | 13.5 | 13.5 |
| Isocyanate IB | 153.0 | 135.0 | 153.0 | 135.0 |
| Index | 113 | 113 | 113 | 113 |
| Processibility | | | | |
| Cream time [s] | 9 | 9 | 7 | 7 |
| Fiber time [s] | 61 | 61 | 65 | 68 |
| Gel time tG [s] | 63 | 68 | 71 | 75 |
| Flow height at tG | 115.1 | 121.3 | 116.1 | 122.7 |
| (1013 hPa) [cm] | | | | |
| Foam properties | | | | |
| Free-foamed density | 23.7 | 22.2 | 24 | 22.8 |
| [g/l] | | | | |
| Compressive strength | 189 ± 20 | 147 ± 17 | 183 ± 16 | 162 ± 15 |
| at 36 kg/m³ [kPa] | | | | |
| Apparent core density | 31.6 ± 0.4 | 30.7 ± 0.3 | 31.9 ± 0.4 | 31.2 ± 0.3 |
| at 36 kg/m³ | | | | |
| Thermal conductivity | 19.1 | 19.8 | 21 | 21.3 |
| [mW/mK] 10° C. | | | | |
| Swelling behavior, | 0.1 | 1.6 | 0.2 | 0.8 |
| MRT 5 min (10 cm) | | | | |
| [mm] | | | | |
| Swelling behavior, | 1 | 2.3 | 1.1 | 1.6 |
| MRT 4 min (10 cm) | | | | |
| [mm] | | | | |

The results show that the foams according to the invention are significantly better in terms of all properties reported than the comparative experiments using a polyol formulation from the prior art which is not according to the invention.

1. A rigid polyurethane foam obtainable by reaction of a foam-forming reaction mixture comprising:
a component A) containing hydrogen atoms which are reactive toward isocyanate groups and comprising a polyol component A1), water A2) and optionally stabilizers A3), catalysts A4) and other auxiliaries and additives A5);
at least one physical blowing agent T); and
a polyisocyanate component B), wherein
the polyol component A1) comprises the following components (i)-(iii), based on the total weight of the component A1):
(i) 60-75% by weight of polyether polyol Ala) having a hydroxyl number of from 300 mg KOH/g to 600 mg KOH/g and a functionality of from 3.0 to 6.0, which is obtainable by addition of an epoxide onto one or more starter compound(s) selected from the group consisting of carbohydrates and bifunctional or higher-functional alcohols;
(ii) 20-35% by weight of polyether polyol A1b) having a hydroxyl number of from 100 mg KOH/g to 550 mg KOH/g and a functionality of from 1.5 to 5.0, which is obtainable by addition of an epoxide or epoxide mixture onto an aromatic amine;
(iii) 3-10% by weight of polyether polyol A1c) having a hydroxyl number of from 15 mg KOH/g to <300 mg KOH/g and a functionality of from 1.5 to 4.0, which is obtainable by addition of an epoxide or epoxide mixture onto one or more starter compound(s) selected from the group consisting of: carbohydrates and bifunctional or higher-functional alcohols, and
wherein the polyisocyanate component B) contains at least 85% by weight (based on the total weight of B) polymeric MDI which has an NCO content of from ≥29.0% by weight to ≤32.0% by weight and a viscosity at 25° C. (EN ISO 3219, October 1994) of from ≥300 mPas to ≤750 mPa·s and comprises, based on its total weight, from ≥25% by weight to ≤40% by weight of monomeric MDI.

2. The rigid polyurethane foam as claimed in claim 1, wherein the polyether polyol Ala) is obtainable by addition of an epoxide or epoxide mixture of ethylene oxide and propylene oxide onto one or more starter compound(s) selected from the group consisting of: mixtures of sucrose and propylene glycol, mixtures of sucrose and ethylene glycol, mixtures of sucrose, propylene glycol and ethylene glycol, mixtures of sucrose and glycerol, mixtures of sorbitol and propylene glycol, mixtures of sorbitol and ethylene glycol, mixtures of sorbitol, propylene glycol and ethylene glycol, and mixtures of sorbitol and glycerol.

3. The rigid polyurethane foam as claimed in claim 1, wherein the polyether polyol Alb) is a polyether polyol started on ortho-, meta- or para-toluenediamine or a mixture of isomeric toluenediamines.

4. The rigid polyurethane foam as claimed in claim 1, wherein the polyether polyol A1c) is a polyether polyol started on glycerol, mixtures of glycerol and propylene glycol, trimethylolpropane, mixtures of trimethylolpropane and propylene glycol, or propylene glycol.

5. The rigid polyurethane foam as claimed in claim 1, wherein the component A) contains ≥1.5% by weight of water A2).

6. The rigid polyurethane foam as claimed in claim 1, wherein the component A) contains ≥1.5% by weight of water A2) and 0.5-5% by weight of a stabilizer A3) selected from the group consisting of: polyether-polydimethylsiloxane copolymers.

7. The rigid polyurethane foam as claimed in claim 1, wherein the polymeric MDI has a viscosity at 25° C. (EN ISO 3219, October 1994) of 350-500 mPa·s (EN ISO 3219, October 1994).

8. The rigid polyurethane foam as claimed in claim 1, additionally containing a catalyst A4) selected from the group consisting of:
triethylenediamine, N,N-dimethylcyclohexylamine, dicyclohexylmethylamine, tetramethylenediamine, 1-methyl-4-dimethylaminoethylpiperazine, triethylamine, tributylamine, dimethylbenzylamine, N,N′,N″-tris(dimethylaminopropyl)hexahydrotriazine, tris(dimethylaminopropyl)amine, tris(dimethylaminomethyl)phenol, dimethylaminopropylformamide, N,N,N′,N′-tetramethylethylenediamine, N,N,N′,N′-tetramethylbutanediamine, tetramethylhexanediamine, pentamethyldiethylenetriamine, pentamethyldipropylenetriamine, bis(dimethylaminoethyl) ether, dimethylpiperazine, 1,2-dimethylimidazole, 1-azabicyclo[3.3.0]octane, bis(di-methylaminopropyl)urea, N-methylmorpholine, N-ethylmorpholine, sodium N-[(2-hydroxy-5-nonylphenyl)methyl]-N-methylaminoacetate, N-cyclohexylmorpholine, 2,3-dimethyl-3,4,5,6-tetrahydropyrimidine, triethanolamine, diethanolamine, triisopropanolamine, N-methyldiethanolamine, N-ethyldiethanolamine and dimethylethanolamine.

9. A process for producing shaped bodies composed of rigid PUR foams as claimed in claim 1, comprising the steps:
a) provision of a mold,
b) introduction of the foam-forming reaction mixture composed of component A), polyisocyanate component B) and blowing agent T) into the mold, and
c) foaming of the reaction mixture.

10. The process as claimed in claim 9, wherein the foam-forming reaction mixture is introduced into the mold under a variable injection pressure and/or in an amount which changes over time.

11. The process as claimed in claim 10, wherein step b) and/or step c) are carried out under reduced pressure.

12. The process as claimed in claim 11, wherein the reaction of the isocyanate component B) with the polyol is carried out at an index of from 100 to 150.

13. A composite system containing a rigid polyurethane foam as claimed in claim 1.

14. An insulation material comprising the composite system as claimed in claim 13.

15. A freezer system comprising the insulation material as claimed in claim 14.

16. The rigid polyurethane foam as claimed in claim 2, wherein the polyether polyol A1a) is obtainable by addition of propylene oxide onto one or more starter compound(s) selected from the group consisting of: mixtures of sucrose and propylene glycol, mixtures of sucrose and ethylene glycol, mixtures of sucrose, propylene glycol and ethylene glycol, mixtures of sucrose and glycerol, mixtures of sorbitol and propylene glycol, mixtures of sorbitol and ethylene glycol, mixtures of sorbitol, propylene glycol and ethylene glycol, and mixtures of sorbitol and glycerol.
